(19) United States
(12) Patent Application Publication
(10) Pub. No.: US 2026/0329986 A1
(43) Pub. Date: Oct. 22, 2026

(54) INFORMATION PROCESSING APPARATUS, CONTROL METHOD OF INFORMATION PROCESSING APPARATUS, AND NON-TRANSITORY COMPUTER-READABLE STORAGE MEDIUM

(71) Applicant: NEC Corporation, Tokyo (JP)

(72) Inventors: Sayo MINOWA, Tokyo (JP); Yusuke MORI, Tokyo (JP); Yu TSUMURAYA, Tokyo (JP); Masatoshi FURUKAWA, Tokyo (JP); Akio YOSHIOKA, Tokyo (JP)

(73) Assignee: NEC Corporation, Tokyo (JP)

(21) Appl. No.: 19/468,042

(22) Filed: Feb. 3, 2026

(30) Foreign Application Priority Data
Mar. 5, 2025 (JP) 2025-035050

(51) Int. Cl. G06F 21/31

(52) U.S. Cl. CPC G06F 21/31

(57) ABSTRACT

An information processing apparatus includes acquisition means, first determination means, second determination means, and cooperation means. The acquisition means acquires first user information, and acquires second user information detected by a sensor mounted on own apparatus. The first determination means determines whether or not a user of the first terminal and a user of the own apparatus are the same based on similarity between the first user information and the second user information. The second determination means determines whether or not the user of the first terminal has received valid authentication on the first terminal. In a case where the user of the first terminal and the user of the own apparatus are the same and the user of the first terminal has received the valid authentication on the first terminal, the cooperation means causes the first terminal and the own apparatus to cooperate with each other.

### INCORPORATION BY REFERENCE

This application is based upon and claims the benefit of priority from Japanese Patent Application No. 2025-035050, filed on Mar. 5, 2025, the disclosure of which is incorporated herein in its entirety by reference.

### TECHNICAL FIELD

The present disclosure relates to an information processing apparatus, a control method of an information processing apparatus, and a non-transitory computer-readable storage medium.

### BACKGROUND ART

There is a technology related to cooperation between a smartwatch worn by a user and VR (Virtual Reality) goggles.

For example, Patent Literature 1 (JP2023-126844A) describes that authentication data is exchanged between both by long-pressing a push switch of a wristwatch-type controller in a state where a head-mounted display is set to a pairing mode.

As described in Patent Literature 1, in order to cause a smartwatch worn by a user and VR goggles to cooperate with each other, manual operation in both terminals or in one of the terminals is required.

However, the manual operation is troublesome for the user, and there is a problem that the cooperation process takes time and effort.

In particular, a user who desires to use functions of a smartwatch or a smartphone during experiencing VR content needs to remove VR goggles and operate the smartwatch or the smartphone, and there is a problem that immersion is impaired.

### SUMMARY

It is a main object of the present disclosure to provide an information processing apparatus, a control method of an information processing apparatus, and a non-transitory computer-readable storage medium that contribute to providing a simpler and more intuitive inter-terminal cooperation method for a user.

According to a first aspect of the present disclosure, there is provided an information processing apparatus including: an acquisition means that acquires first user information detected by a first sensor mounted on a first terminal, and acquires second user information detected by a second sensor mounted on own apparatus; a first determination means that determines whether or not a user of the first terminal and a user of the own apparatus are the same based on similarity between the first user information and the second user information; a second determination means that determines whether or not the user of the first terminal has received valid authentication on the first terminal; and a cooperation means that causes, in a case where the user of the first terminal and the user of the own apparatus are the same and the user of the first terminal has received the valid authentication on the first terminal, the first terminal and the own apparatus to cooperate with each other.

According to a second aspect of the present disclosure, there is provided an information processing apparatus including: an acquisition means that acquires first user information detected by a first sensor mounted on a first terminal, and acquires second user information detected by a second sensor mounted on a second terminal; a first determination means that determines whether or not a user of the first terminal and a user of the second terminal are the same based on similarity between the first user information and the second user information; a second determination means that determines whether or not the user of the first terminal has received valid authentication on the first terminal; and a cooperation means that causes, in a case where the user of the first terminal and the user of the second terminal are the same and the user of the first terminal has received the valid authentication on the first terminal, the first terminal and the second terminal to cooperate with each other.

According to a third aspect of the present disclosure, there is provided a control method of an information processing apparatus, the control method including: an acquisition step that acquires first user information detected by a first sensor mounted on a first terminal, and acquires second user information detected by a second sensor mounted on own apparatus; a first determination step that determines whether or not a user of the first terminal and a user of the own apparatus are the same based on similarity between the first user information and the second user information; a second determination step that determines whether or not the user of the first terminal has received valid authentication on the first terminal; and a cooperation step that causes, in a case where the user of the first terminal and the user of the own apparatus are the same and the user of the first terminal has received the valid authentication on the first terminal, the first terminal and the own apparatus to cooperate with each other.

According to a fourth aspect of the present disclosure, there is provided a non-transitory computer-readable storage medium storing a program causing a computer mounted on an information processing apparatus to perform processing for: an acquisition processing that acquires first user information detected by a first sensor mounted on a first terminal, and acquires second user information detected by a second sensor mounted on own apparatus; a first determination processing that determines whether or not a user of the first terminal and a user of the own apparatus are the same based on similarity between the first user information and the second user information; a second determination processing that determines whether or not the user of the first terminal has received valid authentication on the first terminal; and a cooperation processing that causes, in a case where the user of the first terminal and the user of the own apparatus are the same and the user of the first terminal has received the valid authentication on the first terminal, the first terminal and the own apparatus to cooperate with each other.

### BRIEF DESCRIPTION OF THE DRAWINGS

Exemplary features and advantages of the present disclosure will become apparent from the following detailed description when taken with the accompanying drawings in which:

FIG. 1 is a diagram for illustrating an outline of an example embodiment;

FIG. 2 is a flowchart showing an operation of an example embodiment;

FIG. 3 is a diagram for illustrating utilization of an HMD according to an example embodiment of the present disclosure;

FIG. 4 is a diagram showing an example of a screen display of the HMD according to the example embodiment of the present disclosure;

FIG. 5 is a flowchart showing an example of an operation of the HMD according to the example embodiment of the present disclosure;

FIG. 6 is a diagram showing an example of a processing configuration of the HMD according to the example embodiment of the present disclosure;

FIG. 7 is a diagram showing an example of a screen display of the HMD according to the example embodiment of the present disclosure; and

FIG. 8 is a diagram showing an example of a hardware configuration of the HMD according to the present disclosure.

### EXAMPLE EMBODIMENT

First, an outline of an example embodiment will be described. In the following outline, various components are denoted by reference characters for the sake of convenience.

That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

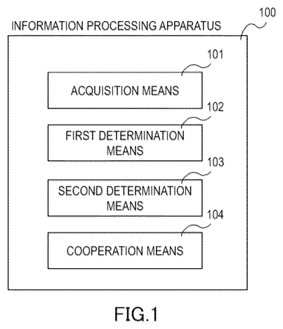

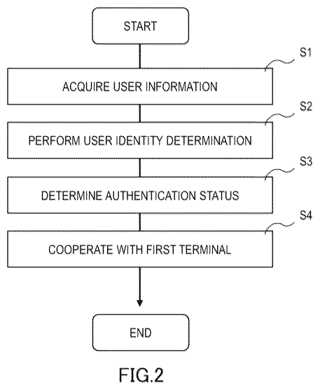

An information processing apparatus 100 according to an example embodiment includes an acquisition means 101, a first determination means 102, a second determination means 103, and a cooperation means 104 (see FIG. 1). The acquisition means 101 acquires first user information detected by a first sensor mounted on a first terminal, and acquires second user information detected by a second sensor mounted on own apparatus (acquire user information; step S1 in FIG. 2). The first determination means 102 determines whether or not a user of the first terminal and a user of the own apparatus are the same based on similarity between the first user information and the second user information (determine identity of users; step S2). The second determination means 103 determines whether or not the user of the first terminal has received valid authentication on the first terminal (determine authentication status; step S3). In a case where the user of the first terminal and the user of the own apparatus are the same and the user of the first terminal has received the valid authentication on the first terminal, the cooperation means 104 causes the first terminal and the own apparatus to cooperate with each other (cooperate with the first terminal; step S4).

The information processing apparatus 100 acquires first user information from the first terminal that the user desires to cooperate with, and acquires second user information from a sensor of the own apparatus. In a case where it is determined, using the two pieces of user information, that the user of the first terminal and the user of the own apparatus (the information processing apparatus 100) are the same, the information processing apparatus 100 determines whether or not the user authentication has succeeded in the first terminal. In a case where the first terminal has succeeded in authenticating the user, the information processing apparatus 100 causes the first terminal to cooperate with the own apparatus. In this manner, since the information processing apparatus 100 does not request the user to perform an operation for cooperating with the first terminal, a simpler and more intuitive inter-terminal cooperation method for the user is realized.

Hereinafter, specific example embodiments will be described in more detail with reference to drawings.

### First Example Embodiment

A first example embodiment will be described in more detail with reference to drawings.

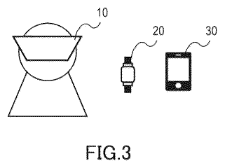

As illustrated in FIG. 3, a user wears a head-mounted display (HMD; Head Mounted Display) 10. In addition, the user uses terminals such as a smartwatch, a smartphone, a tablet, a personal computer, and the like.

More specifically, the user uses a plurality of terminals including the HMD 10 in combination. For example, the user uses a smartwatch 20 together with the HMD 10. At that time, the user receives authentication from each of the HMD 10 and the smartwatch 20. A user determined as authentication success can use the HMD 10 and the smartwatch 20.

It should be noted that the user prepares each of the plurality of terminals to be used so that the terminals are communicable. For example, the user completes pairing between the HMD 10 and the smartwatch 20 by Bluetooth (registered trademark) in advance. In addition, the user completes, as necessary, pairing between the smartwatch 20 and the smartphone 30, and pairing between the HMD 10 and the smartphone 30.

First, functions and the like of the HMD 10 will be outlined.

The HMD 10 is a virtual reality apparatus or an augmented reality apparatus that seamlessly realizes fusion between the real world and virtual digital content. Goggles of the HMD 10 include a high-definition display and can superimpose and display three-dimensional digital content on the real world being visually recognized by the user.

The HMD 10 displays images on each of right and left displays in the goggles. By the respective right and left images, the user can perform three-dimensional spatial recognition. In addition, the HMD 10 includes a video camera installed to be capable of capturing a direction of visual recognition of the user, and employs a video see-through method in which digital content is displayed in an overlaid manner on images captured in real time by the video camera. It should be noted that the HMD 10 may include a single display instead of the respective right and left displays in the goggles, and may display images on the single display.

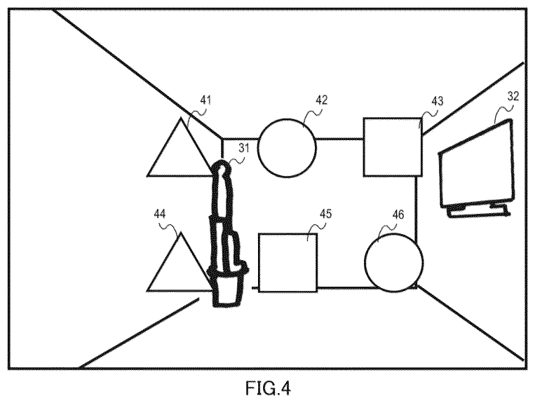

For example, in FIG. 4, a plant 31 and a television 32 are real-world objects captured by the video camera. In contrast, icons 41 to 46 are digital content created by the HMD 10.

An OS (Operating System) is installed in the HMD 10 similarly to a smartphone 30 and the like. In addition, applications operating on the OS are installed in the HMD 10.

Each of icons 41 to 46 illustrated in FIG. 4 is an icon related to various settings of the HMD 10 or an icon for launching an installed application.

In addition, a screen on which icons for settings and for launching applications as illustrated in FIG. 4 are displayed is referred to as a home screen.

The HMD 10 includes a camera capable of capturing eyes (pupils and irises) of a user, and is configured to be capable of detecting gaze of the user (a wearer of the HMD 10). In addition, the HMD 10 includes a camera capable of capturing fingers and the like of the user, and is configured to be capable of detecting a gesture by the user's fingers.

The user can operate the OS and applications of the HMD 10 by gaze and a gesture. In addition, the user can also operate the OS and applications of the HMD 10 by voice.

As described above, the user uses the smartwatch 20 and the smartphone 30 while wearing the HMD 10. At that time, the user causes the HMD 10 to cooperate with another terminal (for example, the smartwatch 20).

For example, a user who plays a VR (Virtual Reality) game on the HMD 10 desires to synchronize movement of an arm with the smartwatch 20 worn on the arm. Alternatively, a user who performs a predetermined task while wearing the HMD 10 desires to cause remote work in a VR space to cooperate with business management on the smartphone 30.

By cooperation between the HMD 10 and the smartwatch 20, customization can also be realized in which the smartwatch 20 detects a reaction of a user who is watching a VR movie on the HMD 10, and the detected reaction is reflected (reflected in real time) in story development of the VR movie.

In order to realize such cooperation between the HMD 10 and another device (the smartwatch 20 and the smartphone 30), it is necessary to confirm that the user of the HMD 10 and the user of the other device are the same person and that the user has legitimate authority to use the HMD 10 and the other device.

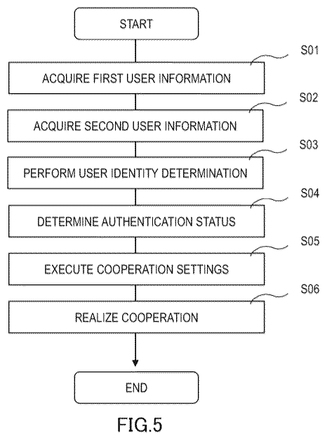

Hereinafter, an operation (an operation of the HMD 10) in a case where the HMD 10 and the smartwatch 20 cooperate with each other will be described with reference to FIG. 5.

First, the user turns on power of the HMD 10. The user wears the activated HMD 10. The HMD 10 detects that the user has worn the HMD 10. Upon the user wearing the HMD 10, the HMD 10 authenticates the user.

Upon authentication success of the user, the HMD 10 acquires first user information related to a user who uses the smartwatch 20 from the smartwatch 20 (step S01). More specifically, the HMD 10 acquires the first user information detected by a first sensor mounted on the smartwatch 20.

The HMD 10 acquires second user information detected by a second sensor mounted on the own apparatus (step S02). The second user information is information related to a user who uses the HMD 10.

The HMD 10 determines whether or not a user of the smartwatch 20 and a user of the HMD 10 are the same person based on similarity between the first user information and the second user information (user identity determination; step S03). For example, the HMD 10 performs the user identity determination using biometric information.

Upon success in the user identity determination, the HMD 10 determines whether or not the user (the user who uses the HMD 10 and the smartwatch 20) has received valid authentication on the smartwatch 20 (authentication status determination; step S04). For example, the HMD 10 inquires of the smartwatch 20 about the authentication status of the user.

Upon receiving a notification from the smartwatch 20 indicating that the user has received valid authentication, the HMD 10 performs settings for realizing cooperation with the smartwatch 20 (execution of cooperation settings; step S05). For example, the HMD 10 acquires a specific cooperation method desired by the user, and performs settings and the like for realizing the cooperation method.

Upon completion of the settings for cooperation, the HMD 10 realizes cooperation with the smartwatch 20 (step S06). For example, a screen displayed on the smartwatch 20 is displayed on a screen of the HMD 10 to realize cooperation.

Subsequently, details of the HMD 10 according to the first example embodiment will be described.

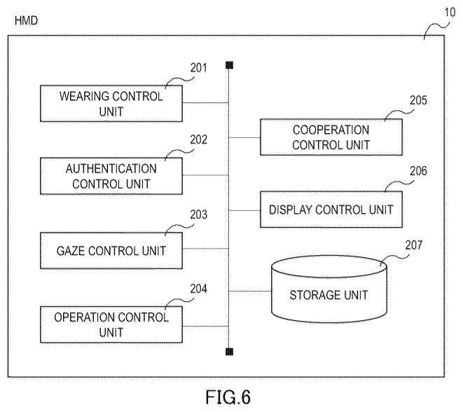

FIG. 6 is a diagram showing an example of a processing configuration (processing modules) of the HMD 10 according to an example embodiment of the present disclosure. Referring to FIG. 6, the HMD 10 includes a wearing control unit 201, an authentication control unit 202, a gaze control unit 203, an operation control unit 204, a cooperation control unit 205, a display control unit 206, and a storage unit 207.

Each module illustrated in FIG. 6 is implemented by an OS or an application of the HMD 10.

The wearing control unit 201 is a control means for detecting that a user has worn the HMD 10 or that the user has removed the HMD 10. The wearing control unit 201 detects start and end of use of the HMD 10 by the user.

The wearing control unit 201 detects that the user has worn the HMD 10 based on image data obtained from a camera installed inside the HMD 10 and output signals obtained from sensors. Similarly, the wearing control unit 201 detects that the user has removed the HMD 10 based on image data and the like obtained from the camera.

Upon detecting that the user has worn the HMD 10, the wearing control unit 201 notifies other modules of that fact. Similarly, upon detecting that the user has removed the HMD 10, the wearing control unit 201 notifies other modules of that fact.

The authentication control unit 202 is a means for authenticating a user who intends to use the HMD 10. The authentication control unit 202 includes a function as a biometric information acquisition means for acquiring biometric information of the user, and a function as an authentication means for authenticating the user based on the acquired biometric information.

For example, the authentication control unit 202 authenticates a user (a person to be authenticated) using biometric information.

It should be noted that examples of the biometric information include data (feature values) calculated from physical features unique to an individual, such as a face, a fingerprint, a voiceprint, a vein, a retina, or an iris pattern of an eye. Alternatively, the biometric information may be image data such as a face image or a fingerprint image. The biometric information may be anything that includes physical characteristics of a user as information. In an example embodiment of the present disclosure, a case where an iris (an iris pattern) is used will be described.

The authentication control unit 202 acquires and stores iris feature values (iris patterns) of the user upon initial use by the user or the like. The authentication control unit 202 acquires and stores iris feature values of one eye or both eyes.

The authentication control unit 202 authenticates the user using the previously acquired iris feature values upon the user using the HMD 10 for a second time or later. The authentication control unit 202 performs authentication processing using iris feature values of the user (a person to be authenticated) and the stored iris feature values.

In a case where the two iris feature values are substantially identical, the authentication control unit 202 determines authentication success. In a case where the two iris feature values do not match, the authentication control unit 202 determines authentication failure.

Upon authentication success of the person to be authenticated, the authentication control unit 202 permits use of the HMD 10 by the user. Upon authentication failure of the person to be authenticated, the authentication control unit 202 rejects use of the HMD 10 by the user. Alternatively, the authentication control unit 202 may treat a user for whom authentication failure is determined as a “guest.” The HMD 10 may limit functions provided to the guest.

It should be noted that existing technologies can be used for calculation of iris feature values and authentication processing using two iris feature values, and thus detailed description thereof will be omitted.

The gaze control unit 203 is a means for executing control related to gaze of the user. For example, the gaze control unit 203 tracks the gaze of the user and identifies (estimates) a gaze direction of the user.

First, the gaze control unit 203 performs calibration for gaze tracking upon initial use of the HMD 10 by the user.

For example, the gaze control unit 203 displays a calibration object on a screen and instructs the user to gaze at the displayed object. The gaze control unit 203 stores a relationship between a position at which the object is displayed and a direction of eyes (pupils) of the user. The gaze control unit 203 displays objects at various locations in a visual field of the user and stores a relationship between the objects and directions of the eyes.

The gaze control unit 203 identifies a gaze direction using directions of the eyes of the user acquired by calibration.

During activation of the HMD 10, the gaze control unit 203 constantly detects (tracks) the gaze direction of the user and notifies other modules of a detection result.

The operation control unit 204 is a means for performing control related to operation of the HMD 10 by the user.

For example, the operation control unit 204 detects an operation of the user based on image data obtained by capturing hands and fingers of the user. For example, the operation control unit 204 detects an action of pinching an object with a thumb and an index finger and an action of releasing the pinched object.

For example, the operation control unit 204 detects an action (a gesture) of the user by inputting image data to an AI (Artificial Intelligence) model prepared in advance.

During activation of the HMD 10, the operation control unit 204 constantly detects actions by fingers of the user (for example, a pinching action and a releasing action). In a case where it is determined, based on a notification from the gaze control unit 203 and the detected action, that the user has performed a predetermined operation, the operation control unit 204 notifies other modules of that fact.

For example, in a case where an icon is displayed on an extension of gaze of the user and the user performs a pinching action, the operation control unit 204 determines that the user has performed an operation related to the icon. For example, the operation control unit 204 notifies other modules of information related to operations, such as “a settings menu has been launched” and “an application has been launched” (hereinafter referred to as operation information).

The cooperation control unit 205 is a means for executing control related to cooperation with another device (for example, the smartwatch 20 and the smartphone 30).

The cooperation control unit 205 includes a function as acquisition means, a function as first determination means, a function as second determination means, and a function as cooperation means.

The acquisition means acquires first user information detected by a first sensor mounted on a first terminal (for example, the smartwatch 20) from the first terminal, and acquires second user information detected by a second sensor mounted on the own apparatus (the HMD 10). The first determination means determines whether or not a user of the first terminal and a user of the own apparatus are the same based on similarity between the first user information and the second user information. The second determination means determines whether or not the user of the first terminal has received valid authentication on the first terminal. In a case where the user of the first terminal and the user of the own apparatus are the same and the user of the first terminal has received valid authentication on the first terminal, the cooperation means causes the first terminal and the own apparatus to cooperate with each other.

The cooperation control unit 205 acquires first user information from a first terminal having a first sensor (for example, the smartwatch 20).

For example, upon becoming communicable with the smartwatch 20 using wireless communication means such as Bluetooth (registered trademark) and Wi-Fi (Wireless Fidelity), the cooperation control unit 205 requests the smartwatch 20 to provide the first user information.

The smartwatch 20 transmits the first user information to the HMD 10 in response to the request. For example, the smartwatch 20 transmits biometric information of the user (biometric information acquired using the first sensor; for example, a heart rate; heart rate information) to the HMD 10.

The cooperation control unit 205 stores the first user information received from the smartwatch 20.

Alternatively, the cooperation control unit 205 may acquire the first user information by voluntary provision from the smartwatch 20.

In addition, the cooperation control unit 205 acquires second user information from a second sensor (for example, a pulse sensor). For example, the cooperation control unit 205 acquires heart rate information of the user as the second user information.

It should be noted that the first and second user information may include not only biometric information (biometric data) of the user but also acceleration information indicating behavior of the user, and the like.

Here, various triggers exist as triggers for the HMD 10 (the cooperation control unit 205) to acquire the first and second user information.

For example, the HMD 10 and the smartwatch 20 may acquire the first and second user information using motion detection as a trigger. For example, in a case where the smartwatch 20 detects a specific movement by the user (for example, the user raises an arm, rotates a wrist, and the like), the smartwatch 20 acquires the first user information and transmits the acquired first user information to the HMD 10. In addition, the HMD 10 may acquire the second user information using detection that the user has worn the HMD 10 as a trigger.

Alternatively, the HMD 10 and the smartwatch 20 may acquire the first and second user information using an output signal of a proximity sensor as a trigger. In a case where the HMD 10 and the smartwatch 20 detect that they have approached within a predetermined distance, the HMD 10 and the smartwatch 20 acquire the first and second user information.

Alternatively, the HMD 10 and the smartwatch 20 may acquire the first and second user information using an explicit operation by the user as a trigger. For example, upon the user pressing a specific button, the smartwatch 20 acquires the first user information. Similarly, upon the user pressing a specific button, the HMD 10 acquires the second user information.

Alternatively, the HMD 10 and the smartwatch 20 may acquire the first and second user information using activation of an application as a trigger. For example, in a case where a specific application (for example, a VR application) is activated, the HMD 10 and the smartwatch 20 automatically acquire the first and second user information.

Alternatively, the HMD 10 and the smartwatch 20 may acquire the first and second user information in response to periodically occurring triggers (automatic triggers). For example, the HMD 10 and the smartwatch 20 may automatically acquire the first and second user information at predetermined intervals and maintain the information in a constantly up-to-date state.

Alternatively, the HMD 10 and the smartwatch 20 may acquire the first and second user information using context recognition as a trigger. For example, the HMD 10 and the smartwatch 20 predict timing of information acquisition based on behavior patterns of the user and time periods, and acquire the first and second user information.

Alternatively, the HMD 10 and the smartwatch 20 may acquire the first and second user information using a voice command as a trigger. For example, in a case where the user utters a specific voice command, the HMD 10 and the smartwatch 20 acquire the first and second user information.

Alternatively, the HMD 10 and the smartwatch 20 may acquire the first and second user information using network connection as a trigger. For example, the HMD 10 and the smartwatch 20 acquire the first and second user information upon being connected to a Wi-Fi (Wireless Fidelity) network.

Alternatively, the HMD 10 and the smartwatch 20 may acquire the first and second user information by a multimodal trigger. For example, in a case where a plurality of conditions (for example, motion detection, a proximity sensor, and a time period) are satisfied simultaneously, the HMD 10 and the smartwatch 20 acquire the first and second user information.

Upon acquiring the first and second user information, the cooperation control unit 205 performs user identity determination. More specifically, the cooperation control unit 205 determines identity of the user by analyzing similarity between the acquired first user information and the second user information.

Here, a case where the cooperation control unit 205 acquires the same type of biometric information (for example, heart rate information) as the first and second user information is considered. The cooperation control unit 205 calculates similarity between the two pieces of heart rate information. For example, the cooperation control unit 205 calculates a high similarity in a case where a difference between the two pieces of heart rate information in a unit time is small, and calculates a low similarity in a case where the difference between the two pieces of heart rate information in the unit time is large.

In a case where similarity between the two pieces of biometric information (heart rate information) is equal to or greater than a threshold, the cooperation control unit 205 determines that users of the HMD 10 and the smartwatch 20 are the same. In a case where similarity between the two pieces of biometric information (heart rate information) is less than the threshold, the cooperation control unit 205 determines that the users of the HMD 10 and the smartwatch 20 are not the same.

In a case where the user identity determination fails (in a case where the user of the HMD 10 and the user of the smartwatch 20 are not the same person), the cooperation control unit 205 does not cause the HMD 10 and the smartwatch 20 to cooperate with each other.

In a case where the user identity determination succeeds (in a case where the user of the HMD 10 and the user of the smartwatch 20 are the same person), the cooperation control unit 205 determines whether or not the user has received valid authentication on the smartwatch 20 (perform authentication status determination).

More specifically, the cooperation control unit 205 inquires of the smartwatch 20 about an authentication status.

The smartwatch 20 replies to the HMD 10 as to whether or not the user has received valid authentication (whether or not authentication success is determined) before the inquiry. For example, the smartwatch 20 notifies the HMD 10 as to whether or not authentication success of the user is determined by password input, biometric authentication (face recognition, iris authentication, fingerprint authentication, voice authentication), and the like.

Upon failure in authentication status determination (in a case where the user has not received authentication on the smartwatch 20), the cooperation control unit 205 does not cause the HMD 10 and the smartwatch 20 to cooperate with each other.

Upon success in authentication status determination (in a case where the user has received authentication on the smartwatch 20), the cooperation control unit 205 performs various settings for realizing cooperation.

For example, the cooperation control unit 205 determines an application (for example, a VR game) in which cooperation between the HMD 10 and the smartwatch 20 is utilized (applied), a screen display method in cooperation, and the like. More specifically, the cooperation control unit 205 presents the user with a list of applications available for cooperation, options of screen display methods, and the like, and acquires an application and a screen display method selected by the user.

For example, the cooperation control unit 205 acquires setting information such as “application: VR game” and “screen display method: display in a separate window.” The cooperation control unit 205 notifies the smartwatch 20 and the display control unit 206 of the determined setting information (information related to settings for realizing cooperation).

The cooperation control unit 205 receives data from the smartwatch 20 as a cooperation partner and delivers the received data to the display control unit 206. In addition, the cooperation control unit 205 delivers the received data to an application (a processing module of the application) that processes the received data. For example, in the above example, the cooperation control unit 205 delivers data to the VR game.

In addition, the cooperation control unit 205 transmits data acquired from an application (for example, the VR game) to the smartwatch 20.

It should be noted that detailed description of individual applications used for cooperation between the HMD 10 and the smartwatch 20 will be omitted. This is because details regarding the individual applications used for cooperation between the HMD 10 and the smartwatch 20 are different from the spirit of the present disclosure.

The display control unit 206 is a display means for executing control related to display of the HMD 10. The display control unit 206 includes a function as a provision means for providing a screen of the first terminal on the own apparatus after cooperation between the first terminal (the smartwatch 20) and the own apparatus (the HMD 10).

The display control unit 206 displays images obtained by capturing the real world on the display in the goggles by the above-described video see-through method, and displays objects such as icons and buttons in an overlaid manner on the images. During activation of the HMD 10, the display control unit 206 repeats the operation.

As described above, the display control unit 206 acquires setting information from the operation control unit 204. The display control unit 206 realizes cooperation between the HMD 10 and the smartwatch 20 in accordance with the screen display method described in the setting information.

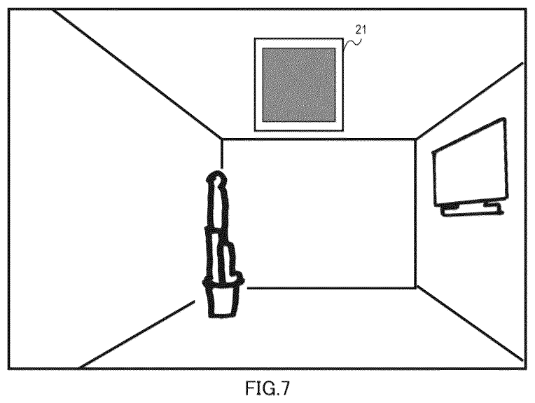

For example, in a case where “screen display method: display in a separate window” is acquired, the display control unit 206 sets a window 21 on the screen as illustrated in FIG. 7. The display control unit 206 displays data acquired from an application (for example, a VR game) and the cooperation control unit 205 in the set window 21.

The storage unit 207 is a means for storing information necessary for operation of the HMD 10.

Next, variations according to the first example embodiment will be described.

### <Variation 1>

In the above example embodiment, a case where the HMD 10 acquires the first user information directly from the smartwatch 20 has been described. However, the HMD 10 may acquire the first user information from a terminal different from the smartwatch 20.

For example, the HMD 10 may acquire the first user information via the smartphone 30. For example, in a case where the HMD 10 cannot directly communicate with the smartwatch 20, the HMD 10 may acquire the first user information via the smartphone 30 connected to the smartwatch 20.

In this case, the smartphone 30 communicates with both the HMD 10 and the smartwatch 20. The smartphone 30 only needs to relay data transmitted and received between the HMD 10 and the smartwatch 20.

### <Variation 2>

The HMD 10 may cooperate with the smartphone 30 connected to the smartwatch 20.

In this case, the HMD 10 determines that a user of the smartphone 30 connected to the smartwatch 20 and a user of the HMD 10 are the same based on similarity between the first user information and the second user information.

More specifically, the cooperation control unit 205 handles the first user information acquired via the smartphone 30 (information related to a user who uses the smartwatch 20) as information related to a user who uses the smartphone 30. The cooperation control unit 205 determines whether or not a user of the smartphone 30 and a user of the HMD 10 are the same person based on the first user information acquired via the smartphone 30 and the second user information.

In a case where it is determined that a user of the smartphone 30 and a user of the HMD 10 are the same person and the user of the smartwatch 20 has received valid authentication on the smartwatch 20, the cooperation control unit 205 realizes cooperation between the smartphone 30 and the HMD 10. More specifically, after cooperation between the HMD 10 and the smartphone 30, the display control unit 206 displays a screen of the smartphone 30 on a screen of the HMD 10 (realize cooperation).

It should be noted that a fact that the smartwatch 20 and the smartphone 30 are connected can be interpreted that a user of the smartwatch 20 is permitted to use the smartphone 30. Therefore, it is also possible for the HMD 10 to regard a user authenticated on the smartwatch 20 as a user authenticated on the smartphone 30.

The cooperation control unit 205 analyzes similarity between the first user information and the second user information, and determines (identifies) whether or not a user of the smartwatch 20 and/or a user of the smartphone 30 and a user of the HMD 10 are the same.

In this manner, the cooperation control unit 205 (first determination means) determines whether or not a user of a second terminal (the smartphone 30) connected to the first terminal (the smartwatch 20) and a user of the own apparatus are the same based on the similarity between the first user information and the second user information. In a case where a user of the second terminal and a user of the own apparatus are the same and the user of the first terminal has received the valid authentication on the first terminal, the cooperation control unit 205 (cooperation means) causes the second terminal and the own apparatus to cooperate with each other. In addition, after cooperation between the second terminal and the own apparatus, the display control unit 206 (provision means) provides a screen of the second terminal (for example, the smartphone 30) on the own apparatus (the HMD 10).

By such cooperation between the HMD 10 and the smartphone 30, the user can access functions of the smartphone 30 without interrupting a VR experience.

### <Variation 3>

The HMD 10 may perform advanced determination (identification) of the first and second user information using a machine learning model.

Similarity (similarity degree) between the first and second user information may fluctuate due to movement of the user and changes in an environment. If the fluctuation occurs, the HMD 10 cannot make accurate determination.

The cooperation control unit 205 acquires the first and second user information. The cooperation control unit 205 inputs the acquired two pieces of user information to the machine learning model. The machine learning model analyzes similarity degree and outputs a score (similarity degree). The cooperation control unit 205 performs threshold processing on the score and determines a result of the user identity determination based on the result.

In this manner, a machine learning model trained in advance is built into the HMD 10. The cooperation control unit 205 (first determination means) calculates similarity degree between the first user information and the second user information using the machine learning model. More specifically, the cooperation control unit 205 inputs the acquired two pieces of user information to the machine learning model and acquires similarity degree. By using the machine learning model, the HMD 10 can perform highly accurate user identification (identity determination) under various conditions, and can prevent incorrect cooperation.

### <Variation 4>

The HMD 10 may realize improvement in accuracy of user identity determination in consideration of position information of the smartwatch 20 and the HMD 10.

In determination using movement and biometric information of the user, the HMD 10 may erroneously identify another user having similar characteristics (erroneously determine that the user of the HMD 10 and the user of the smartwatch 20 are the same).

The cooperation control unit 205 acquires the first and second user information and position information of each of the HMD 10 and the smartwatch 20. The cooperation control unit 205 calculates the position information using GPS (Global Positioning System) signals. Similarly, the smartwatch 20 also calculates position information and provides the calculated position information to the HMD 10 together with the first user information.

The cooperation control unit 205 determines whether or not the HMD 10 and the smartwatch 20 exist within a predetermined distance using the acquired two pieces of position information.

In a case where the HMD 10 and the smartwatch 20 exist within the predetermined distance, the cooperation control unit 205 calculates similarity using the first and second users and performs user identity determination.

In a case where the HMD 10 and the smartwatch 20 do not exist within the predetermined distance, the cooperation control unit 205 ends processing without performing the user identity determination. In this case, cooperation between the HMD 10 and the smartwatch 20 is not performed.

It should be noted that the cooperation control unit 205 may notify the user of an identification result (a result of the user identity determination) via a screen of the HMD 10 or the smartwatch 20.

In this manner, the cooperation control unit 205 (acquisition means) acquires position information of the first terminal (for example, the smartwatch 20) and position information of the own apparatus (the HMD 10). In a case where the position information of the first terminal and the position information of the own apparatus indicate that the first terminal and the own apparatus are within a predetermined distance, the cooperation control unit 205 (first determination means) determines whether or not the user of the first terminal and the user of the own apparatus are the same.

As described above, the cooperation control unit 205 can perform more accurate user identification (user identity determination) by taking position information of the HMD 10 and the smartwatch 20 into consideration. As a result, security is improved. In addition, accuracy of identification (user identity determination) is improved, and a risk of incorrect cooperation is reduced.

### <Variation 5>

The first user information and the second user information may be acceleration information. The HMD 10 may perform similarity determination (user identity determination) using the first user information and the second user information using acceleration information. The HMD 10 may eliminate the need for a special operation (an operation by the user) required for causing a plurality of terminals to cooperate with each other by using the acceleration information.

A user who wears the smartwatch 20 on a wrist presses a switch of the smartwatch 20 and a switch of the HMD 10, and then picks up the HMD 10 and wears the HMD 10 on a head.

Upon a switch of the own device being pressed, the smartwatch 20 acquires acceleration information as the first user information. The smartwatch 20 transmits the acquired first user information (acceleration information) to the HMD 10.

Upon a switch of the HMD 10 being pressed, the cooperation control unit 205 acquires acceleration information as the second user information.

The cooperation control unit 205 compares and analyzes movement patterns of the HMD 10 and the smartwatch 20 using the two pieces of acceleration information using a machine learning model and the like. The cooperation control unit 205 identifies the user based on similarity in movement (performs user identity determination).

For example, the cooperation control unit 205 acquires two pieces of acceleration information and time information in combination, the acceleration information being obtained at a time at which a user wearing the smartwatch 20 holds the HMD 10 in a hand and wears the HMD 10 on a head. In a case where the two pieces of acceleration information indicate similar movements at the same time, the cooperation control unit 205 determines that the user wearing the smartwatch 20 on a wrist has worn the HMD 10 on the head. That is, the cooperation control unit 205 can perform user identity determination based on similarity between movements of the HMD 10 and the smartwatch 20 at the same time.

In this manner, the HMD 10 calculates similarity between movements of the HMD 10 and the smartwatch 20 using acceleration information and performs user identity determination. As a result, the user can cause a plurality of terminals (for example, the HMD 10 and the smartwatch 20) to cooperate with each other without performing a special operation.

### <Variation 6>

As described above, the HMD 10 can perform user identity determination using biometric information. That is, the first user information includes biometric information of a user of the first terminal (for example, the smartwatch 20), and the second user information includes biometric information of a user of the own apparatus (the HMD 10). Here, variations and the like of user identity determination using the biometric information will be described.

The cooperation control unit 205 acquires biometric information of the user of the smartwatch 20 as the first user information. In addition, the cooperation control unit 205 acquires biometric information of the user of the HMD 10 as the second user information. The cooperation control unit 205 acquires biometric information of the user of the smartwatch 20 and biometric information of the user of the HMD 10 from biometric sensors of the smartwatch 20 and the HMD 10. The cooperation control unit 205 compares and analyzes the two pieces of biometric information.

For example, the cooperation control unit 205 acquires blood pressure information of the user of the smartwatch 20 from a blood pressure sensor mounted on the smartwatch 20. In addition, the cooperation control unit 205 acquires blood pressure information of the user of the HMD 10 from a blood pressure sensor mounted on the HMD 10.

The cooperation control unit 205 analyzes the two pieces of blood pressure information in time series and evaluates similarity between blood pressure patterns at the same time (time series). The cooperation control unit 205 performs user identity determination based on similarity between blood pressure patterns at the same time.

Alternatively, the cooperation control unit 205 may use voice information as biometric information. In this case, the smartwatch 20 acquires voice information of the user of the smartwatch 20 from a microphone mounted on the own terminal. The smartwatch 20 transmits the acquired voice information to the HMD 10 as the first user information.

In addition, the cooperation control unit 205 acquires voice information of the user of the HMD 10 from a microphone mounted on the HMD 10.

The cooperation control unit 205 analyzes the two pieces of voice information in time series and evaluates similarity between voice patterns at the same time (time series). The cooperation control unit 205 performs user identity determination based on similarity between voice patterns at the same time.

In this manner, the HMD 10 may calculate similarity between biometric information of the user of the smartwatch 20 and biometric information of the user of the HMD 10, and may perform user identity determination. As a result, the user can cause a plurality of terminals (for example, the HMD 10 and the smartwatch 20) to cooperate with each other without performing a special operation.

### <Variation 7>

The HMD 10 may perform similarity determination (user identity determination) of a walking pattern of the user using the first and second user information.

The smartwatch 20 acquires acceleration information obtained from an acceleration sensor of the smartwatch 20 as the first user information. The smartwatch 20 transmits the acquired acceleration information to the HMD 10.

The cooperation control unit 205 acquires acceleration information obtained from an acceleration sensor of the HMD 10 as the second user information.

The cooperation control unit 205 analyzes walking patterns of users of the HMD 10 and the smartwatch 20 from the two pieces of acceleration information. The cooperation control unit 205 compares and analyzes walking pattern information of the users of both terminals (the HMD 10 and the smartwatch 20). The cooperation control unit 205 identifies the user based on similarity of walking patterns (performs user identity determination).

In this manner, the cooperation control unit 205 (first determination means) analyzes a walking pattern of the user of the first terminal (for example, the smartwatch 20) based on the first user information. The cooperation control unit 205 analyzes a walking pattern of the user of the own apparatus (the HMD 10) based on the second user information. The cooperation control unit 205 determines whether or not the user of the first terminal and the user of the own apparatus are the same based on similarity between the walking pattern of the user of the first terminal and the walking pattern of the user of the own apparatus.

As described above, the HMD 10 may calculate similarity between a walking pattern of the user of the smartwatch 20 and a walking pattern of the user of the HMD 10, and may perform user identity determination. As a result, the user can cause a plurality of terminals (the HMD 10 and the smartwatch 20) to cooperate with each other without performing a special operation.

As described above, the HMD 10 according to the first example embodiment acquires the first user information from a first terminal (for example, the smartwatch 20) that the user desires to cooperate with, and acquires the second user information from a sensor of the own apparatus. In a case where it is determined, using the two pieces of user information, that the user of the first terminal and the user of the own apparatus are the same, the HMD 10 determines whether or not authentication success of the user is determined in the first terminal. In a case where the first terminal has succeeded in authenticating the user, the HMD 10 cooperates with the first terminal. Since the HMD 10 does not request the user to perform an operation for cooperating with the first terminal, a simpler and more intuitive inter-terminal cooperation method for the user is realized. Upon inter-terminal cooperation being realized, the HMD 10 provides a screen of the first terminal (for example, the smartwatch 20) on the own apparatus (the HMD 10). By such operation of the HMD 10, the user can access functions of the first terminal.

In this manner, the HMD 10 according to the present disclosure improves efficiency of cooperation among a plurality of terminals such as the smartwatch 20 and the smartphone 30. The HMD 10 is an information processing apparatus that improves user experience. In particular, inter-terminal cooperation is automated by using similarity of movements and biometric information of the user detected by each of the smartwatch 20 and VR goggles (the HMD 10). As a result, the HMD 10 can seamlessly support various activities of the user in a VR space.

In addition, the HMD 10 according to the present disclosure can automatically cause a plurality of terminals (the smartwatch 20 and/or the smartphone 30, and the HMD 10) to cooperate with each other while minimizing manual operations by the user. By such operation of the HMD 10, convenience of the user is significantly improved. Furthermore, since the user is identified based on similarity between the first user information and the second user information, smooth inter-terminal cooperation is realized while maintaining security. Furthermore, the HMD 10 improves user experience by omitting an additional authentication process using prior authentication on the first terminal (the smartwatch 20). That is, from a security viewpoint, an authentication process for confirming that the user has legitimate authority is necessary, but execution of the authentication process is omitted.

Furthermore, the HMD 10 according to the present disclosure can provide a screen of a second terminal (for example, the smartphone 30) on the HMD 10. As a result, the user can access functions of the smartphone 30 without interrupting a VR experience. That is, the HMD 10 displays a screen of the first terminal and/or the second terminal on the own apparatus, thereby enabling the user to seamlessly access functions of the second terminal (the smartphone 30) in a VR environment.

Furthermore, the HMD 10 according to the present disclosure can perform more accurate user identification (user identity determination) by using a machine learning model and utilizing various types of data such as position information, acceleration information, biometric information, and walking patterns.

As described above, the HMD 10 according to the present disclosure can provide a seamless and intuitive experience to a user who owns a plurality of terminals and can greatly expand an application range of VR technology. That is, the modules (components) included in the HMD 10 operate in cooperation with each other, thereby improving convenience of the user and expanding the application range of the VR technology.

### Second Example Embodiment

Next, a second example embodiment will be described in detail with reference to drawings.

All or a part of the functions of the HMD 10 described above may be implemented by another apparatus. More specifically, functions related to cooperation between the HMD 10 and the smartwatch 20 and the like may be implemented by a server apparatus on a network.

In this case, the server apparatus includes acquisition means, first determination means, second determination means, and cooperation means.

An account of the user is generated in the server apparatus. The user logs into the account of the server apparatus using the smartwatch 20. Similarly, the user logs into the account of the server apparatus using the HMD 10.

The acquisition means acquires first user information detected by a first sensor mounted on a first terminal (for example, the smartwatch 20). In addition, the acquisition means acquires second user information detected by a second sensor mounted on a second terminal (for example, the HMD 10). For example, the acquisition means acquires the first and second user information by instructing each of the first terminal and the second terminal to provide the first user information and the second user information.

The first determination means determines whether or not a user of the first terminal and a user of the second terminal are the same based on similarity between the first user information and the second user information. For example, the first determination means determines whether or not the users of the two terminals are the same using heart rate information, blood pressure information, and the like of the user.

The second determination means determines whether or not the user of the first terminal has received valid authentication on the first terminal. For example, the second determination means inquires of the first terminal about an authentication status of the user.

In a case where the user of the first terminal and the user of the second terminal are the same and the user of the first terminal has received valid authentication on the first terminal, the cooperation means causes the first terminal and the second terminal to cooperate with each other. More specifically, the cooperation means instructs the first and second terminals to start inter-terminal cooperation. The first and second terminals receiving the instruction determine a specific cooperation method and realize inter-terminal cooperation.

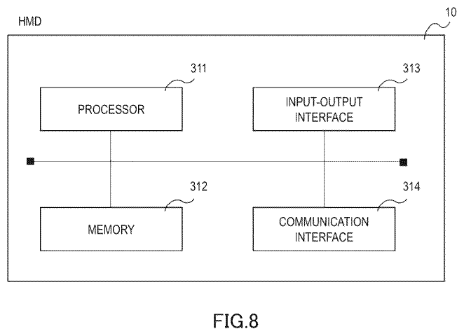

Next, a hardware configuration of an individual apparatus that constitutes the information processing system will be described. FIG. 8 is a diagram illustrating an example of a hardware configuration of the HMD 10.

The HMD 10 can be configured by an information processing apparatus (so-called computer) and includes a configuration exemplified in FIG. 8. For example, the HMD 10 includes a processor 311, a memory 312, an input-output interface 313, and a communication interface 314, and the like. The above-described components such as the processor 311 are connected via an internal bus or the like and are configured to be capable of communicating with each other.

However, the configuration shown in FIG. 8 is not intended to limit the hardware configuration of the HMD 10. The HMD 10 may include hardware not illustrated in the figure, and may omit the input-output interface 313 as needed. In addition, the number of components such as the processor 311 included in the HMD 10 is not intended to be limited to the example shown in FIG. 8, and, for example, a plurality of processors 311 may be included in the HMD 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and the like. The memory 312 stores an OS program, an application program, and various kinds of data.

The input-output interface 313 is an interface for a display apparatus and an input apparatus not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes an NIC (Network Interface Card), and the like.

The functions of the HMD 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

The HMD 10, which is an information processing apparatus, is equipped with a computer, and the functions of the HMD 10 can be realized by causing the computer to execute a program. In addition, the HMD 10 executes a control method of the HMD 10 by using this program.

### [Variations]

It should be noted that the configurations, operations, and the like of the information processing system according to the above example embodiments are examples and do not limit the present system configuration, and the like.

In the above example embodiments, description has been given taking, as an example, the HMD 10 adopting a video see-through method. However, the HMD 10 may perform screen display by adopting an optical see-through method.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to a head mounted display and the like that seamlessly realizes fusion of the real world and virtual digital content.

The present disclosure may additionally include the following example embodiments. More specifically, example embodiments related to hardware improvements may be added. For example, the information processing apparatus (the HMD 10) of the present disclosure includes a dedicated high-speed data processing chip. The chip is optimized so as to be able to perform similarity analysis between the first user information and the second user information at high speed and with low power consumption. As a result, high-speed and real-time inter-terminal cooperation that could not be realized by existing general-purpose processors becomes possible.

Alternatively, the information processing apparatus (the HMD 10) may include a dedicated similarity analysis chip that performs similarity analysis between the first user information and the second user information. The chip may be implemented as an ASIC (Application Specific Integrated Circuit) combined with a neural network accelerator. The similarity analysis chip includes a plurality of parallel processing units and can compare respective elements of the first user information and the second user information simultaneously. In addition, the chip includes a dedicated memory cache, and can retrieve frequently accessed data at high speed. With such a similarity analysis chip, processing speed can be improved while reducing power consumption as compared with existing software-based solutions.

Alternatively, the first terminal and the HMD 10 may include a highly accurate motion detection sensor. The sensor can detect movement of the user with higher accuracy than existing acceleration sensors and angular velocity sensors and can acquire more detailed motion patterns. A newly developed ultra-high-precision MEMS (Micro Electro Mechanical Systems) sensor may be mounted on the first terminal and the HMD 10. The sensor integrates functions of an existing acceleration sensor and an existing angular velocity sensor into one chip and further includes a barometric pressure sensor and a geomagnetic sensor. The sensor chip includes a dedicated signal processing circuit, integrates data of various sensors to remove noise, and can detect movement of the user in a three-dimensional space with high accuracy. In addition, the sensor chip includes a unique power saving mode and automatically shifts to a low power consumption state in a case where no movement is detected. As a result, the HMD 10 and the like can perform continuous monitoring while extending battery life.

Alternatively, a dedicated security chip may be mounted on the information processing apparatus (the HMD 10). The chip may encrypt inter-terminal communication and perform authentication processing for preventing spoofing attacks. A dedicated security chip capable of processing the latest encryption algorithms at high speed may be mounted on the information processing apparatus (the HMD 10). The chip includes a random number generator at a hardware level and generates a strong encryption key using a true random number. In addition, the chip includes a secure key storage area therein and is configured so that the encryption key cannot be read from outside. Furthermore, the chip has resistance to side-channel attacks and prevents information from being inferred from power consumption patterns and electromagnetic leakage. With the security chip, inter-terminal communication is always encrypted, and eavesdropping and tampering by a third party are prevented.

With the above example embodiments, it is apparent that the present disclosure is not merely an abstract idea but a technical solution involving specific hardware improvements.

A part or the entirety of the example embodiments described above may be described as in the following supplementary notes, but is not limited to the followings.

### [Supplementary Note 1]

An information processing apparatus including:
an acquisition means that acquires first user information detected by a first sensor mounted on a first terminal, and acquires second user information detected by a second sensor mounted on own apparatus;
a first determination means that determines whether or not a user of the first terminal and a user of the own apparatus are the same based on similarity between the first user information and the second user information;
a second determination means that determines whether or not the user of the first terminal has received valid authentication on the first terminal;
and a cooperation means that causes, in a case where the user of the first terminal and the user of the own apparatus are the same and the user of the first terminal has received the valid authentication on the first terminal, the first terminal and the own apparatus to cooperate with each other.

### [Supplementary Note 2]

The information processing apparatus according to supplementary note 1, further including a provision means for providing a screen of the first terminal on the own apparatus after cooperation between the first terminal and the own apparatus.

### [Supplementary Note 3]

The information processing apparatus according to supplementary note 2, wherein the first determination means determines whether or not a user of a second terminal connected to the first terminal and the user of the own apparatus are the same based on the similarity between the first user information and the second user information, and
wherein the cooperation means causes, in a case where the user of the second terminal and the user of the own apparatus are the same and the user of the first terminal has received the valid authentication on the first terminal, the second terminal and the own apparatus to cooperate with each other, and
wherein the provision means provides, after the cooperation between the second terminal and the own apparatus, a screen of the second terminal on the own apparatus.

### [Supplementary Note 4]

The information processing apparatus according to supplementary note 2 or 3, wherein the first determination means calculates the similarity between the first user information and the second user information using a machine learning model.

### [Supplementary Note 5]

The information processing apparatus according to supplementary note 2 or 3, wherein the acquisition means acquires position information of the first terminal and position information of the own apparatus, and
wherein the first determination means determines, in a case where the position information of the first terminal and the position information of the own apparatus indicate that the first terminal and the own apparatus are within a predetermined distance, whether or not the user of the first terminal and the user of the own apparatus are the same.

### [Supplementary Note 6]

The information processing apparatus according to supplementary note 2 or 3, wherein the first user information and the second user information are acceleration information.

### [Supplementary Note 7]

The information processing apparatus according to supplementary note 2 or 3, wherein the first user information includes biometric information of the user of the first terminal, and
wherein the second user information includes biometric information of the user of the own apparatus.

### [Supplementary Note 8]

The information processing apparatus according to supplementary note 6, wherein the first determination means analyzes a walking pattern of the user of the first terminal based on the first user information, analyzes a walking pattern of the user of the own apparatus based on the second user information, and determines whether or not the user of the first terminal and the user of the own apparatus are the same based on similarity between the walking pattern of the user of the first terminal and the walking pattern of the user of the own apparatus.

### [Supplementary Note 9]

The information processing apparatus according to supplementary note 3, wherein the first terminal is a smartwatch, and the second terminal is a smartphone.

### [Supplementary Note 10]

An information processing apparatus including:
an acquisition means that acquires first user information detected by a first sensor mounted on a first terminal, and acquires second user information detected by a second sensor mounted on a second terminal;
a first determination means that determines whether or not a user of the first terminal and a user of the second terminal are the same based on similarity between the first user information and the second user information;
a second determination means that determines whether or not the user of the first terminal has received valid authentication on the first terminal;
and a cooperation means that causes, in a case where the user of the first terminal and the user of the second terminal are the same and the user of the first terminal has received the valid authentication on the first terminal, the first terminal and the second terminal to cooperate with each other.

### [Supplementary Note 11]

A control method of an information processing apparatus, the control method including:
an acquisition step that acquires first user information detected by a first sensor mounted on a first terminal, and acquires second user information detected by a second sensor mounted on own apparatus;
a first determination step that determines whether or not a user of the first terminal and a user of the own apparatus are the same based on similarity between the first user information and the second user information;
a second determination step that determines whether or not the user of the first terminal has received valid authentication on the first terminal;
and a cooperation step that causes, in a case where the user of the first terminal and the user of the own apparatus are the same and the user of the first terminal has received the valid authentication on the first terminal, the first terminal and the own apparatus to cooperate with each other.

### [Supplementary Note 12]

The control method of the information processing apparatus according to supplementary note 11, further including a provision step for providing a screen of the first terminal on the own apparatus after cooperation between the first terminal and the own apparatus.

### [Supplementary Note 13]

The control method of the information processing apparatus according to supplementary note 12, wherein the first determination step determines whether or not a user of a second terminal connected to the first terminal and the user of the own apparatus are the same based on the similarity between the first user information and the second user information, and
wherein the cooperation step causes, in a case where the user of the second terminal and the user of the own apparatus are the same and the user of the first terminal has received the valid authentication on the first terminal, the second terminal and the own apparatus to cooperate with each other, and
wherein the provision step provides, after the cooperation between the second terminal and the own apparatus, a screen of the second terminal on the own apparatus.

### [Supplementary Note 14]

The control method of the information processing apparatus according to supplementary note 12 or 13, wherein the first determination step calculates the similarity between the first user information and the second user information using a machine learning model.

### [Supplementary Note 15]

The control method of the information processing apparatus according to supplementary note 12 or 13, wherein the acquisition step acquires position information of the first terminal and position information of the own apparatus, and
wherein the first determination step determines, in a case where the position information of the first terminal and the position information of the own apparatus indicate that the first terminal and the own apparatus are within a predetermined distance, whether or not the user of the first terminal and the user of the own apparatus are the same.

### [Supplementary Note 16]

The control method of the information processing apparatus according to supplementary note 12 or 13, wherein the first user information and the second user information are acceleration information.

### [Supplementary Note 17]

The control method of the information processing apparatus according to supplementary note 12 or 13, wherein the first user information includes biometric information of the user of the first terminal, and
wherein the second user information includes biometric information of the user of the own apparatus.

### [Supplementary Note 18]

The control method of the information processing apparatus according to supplementary note 16, wherein the first determination step analyzes a walking pattern of the user of the first terminal based on the first user information, analyzes a walking pattern of the user of the own apparatus based on the second user information, and determines whether or not the user of the first terminal and the user of the own apparatus are the same based on similarity between the walking pattern of the user of the first terminal and the walking pattern of the user of the own apparatus.

### [Supplementary Note 19]

The control method of the information processing apparatus according to supplementary note 13, wherein the first terminal is a smartwatch, and the second terminal is a smartphone.

### [Supplementary Note 20]

A control method of an information processing apparatus, the control method including:
an acquisition step that acquires first user information detected by a first sensor mounted on a first terminal, and acquires second user information detected by a second sensor mounted on a second terminal;
a first determination step that determines whether or not a user of the first terminal and a user of the second terminal are the same based on similarity between the first user information and the second user information;
a second determination step that determines whether or not the user of the first terminal has received valid authentication on the first terminal;
and a cooperation step that causes, in a case where the user of the first terminal and the user of the second terminal are the same and the user of the first terminal has received the valid authentication on the first terminal, the first terminal and the second terminal to cooperate with each other.

### [Supplementary Note 21]

A program causing a computer mounted on an information processing apparatus to perform processing for:
an acquisition processing that acquires first user information detected by a first sensor mounted on a first terminal, and acquires second user information detected by a second sensor mounted on own apparatus;
a first determination processing that determines whether or not a user of the first terminal and a user of the own apparatus are the same based on similarity between the first user information and the second user information;
a second determination processing that determines whether or not the user of the first terminal has received valid authentication on the first terminal;
and a cooperation processing that causes, in a case where the user of the first terminal and the user of the own apparatus are the same and the user of the first terminal has received the valid authentication on the first terminal, the first terminal and the own apparatus to cooperate with each other.

### [Supplementary Note 22]

The program according to supplementary note 21, further including a provision processing for providing a screen of the first terminal on the own apparatus after cooperation between the first terminal and the own apparatus.

### [Supplementary Note 23]

The program according to supplementary note 22, wherein the first determination processing determines whether or not a user of a second terminal connected to the first terminal and the user of the own apparatus are the same based on the similarity between the first user information and the second user information, and
wherein the cooperation processing causes, in a case where the user of the second terminal and the user of the own apparatus are the same and the user of the first terminal has received the valid authentication on the first terminal, the second terminal and the own apparatus to cooperate with each other, and
wherein the provision processing provides, after the cooperation between the second terminal and the own apparatus, a screen of the second terminal on the own apparatus.

### [Supplementary Note 24]

The program according to supplementary note 22 or 23, wherein the first determination processing calculates the similarity between the first user information and the second user information using a machine learning model.

### [Supplementary Note 25]

The program according to supplementary note 22 or 23, wherein the acquisition processing acquires position information of the first terminal and position information of the own apparatus, and
wherein the first determination processing determines, in a case where the position information of the first terminal and the position information of the own apparatus indicate that the first terminal and the own apparatus are within a predetermined distance, whether or not the user of the first terminal and the user of the own apparatus are the same.

### [Supplementary Note 26]

The program according to supplementary note 22 or 23, wherein the first user information and the second user information are acceleration information.

### [Supplementary Note 27]

The program according to supplementary note 22 or 23, wherein the first user information includes biometric information of the user of the first terminal, and
wherein the second user information includes biometric information of the user of the own apparatus.

### [Supplementary Note 28]

The program according to supplementary note 26, wherein the first determination processing analyzes a walking pattern of the user of the first terminal based on the first user information, analyzes a walking pattern of the user of the own apparatus based on the second user information, and determines whether or not the user of the first terminal and the user of the own apparatus are the same based on similarity between the walking pattern of the user of the first terminal and the walking pattern of the user of the own apparatus.

### [Supplementary Note 29]

The program according to supplementary note 23, wherein the first terminal is a smartwatch, and the second terminal is a smartphone.

### [Supplementary Note 30]

A program causing a computer mounted on an information processing apparatus to perform processing for:
an acquisition processing that acquires first user information detected by a first sensor mounted on a first terminal, and acquires second user information detected by a second sensor mounted on a second terminal;
a first determination processing that determines whether or not a user of the first terminal and a user of the second terminal are the same based on similarity between the first user information and the second user information;
a second determination processing that determines whether or not the user of the first terminal has received valid authentication on the first terminal;
and a cooperation processing that causes, in a case where the user of the first terminal and the user of the second terminal are the same and the user of the first terminal has received the valid authentication on the first terminal, the first terminal and the second terminal to cooperate with each other.

In addition, a part or all of the configurations described in supplementary notes 2 to 9, which are dependent on supplementary note 1 as described above, may also be dependent on supplementary notes 10 and 21 in the same dependent relationship as supplementary notes 2 to 9. Furthermore, not limited to supplementary note 1 and supplementary notes 10 and 21, within a range not departing from the above-described example embodiments, a part or all of the configurations described as supplementary notes can likewise be made dependent on various hardware, software, various recording means for recording the software, or systems.

It should be noted that the entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and spirit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. An information processing apparatus comprising:
at least one memory storing a set of instructions; and
at least one processor configured to execute the set of instructions to:
acquire first user information detected by a first sensor mounted on a first terminal;
acquire second user information detected by a second sensor mounted on own apparatus;
determine whether or not a user of the first terminal and a user of the own apparatus are t same based on similarity between the first user information and the second user information;
determine whether or not the user of the first terminal has received valid authentication on the first terminal; and
cause, in a case where the user of the first terminal and the user of the own apparatus are the same and the user of the first terminal has received the valid authentication on the first terminal, the first terminal and the own apparatus to cooperate with each other.

2. The information processing apparatus according to claim 1, wherein
the at least one processor is further configured to execute the set of instructions to:
determine whether or not a user of a second terminal connected to the first terminal and the user of the own apparatus are the same based on the similarity between the first user information and the second user information; and
cause, in a case where the user of the second terminal and the user of the own apparatus are the same and the user of the first terminal has received the valid authentication on the first terminal, the second terminal and the own apparatus to cooperate with each other.

3. The information processing apparatus according to claim 1, wherein
the at least one processor is further configured to execute the set of instructions to calculate the similarity between the first user information and the second user information using a machine learning model.

4. The information processing apparatus according to claim 2, wherein
the at least one processor is further configured to execute the set of instructions to calculate the similarity between the first user information and the second user information using a machine learning model.

5. The information processing apparatus according to claim 1, wherein
the at least one processor is further configured to execute the set of instructions to:
acquire position information of the first terminal and position information of the own apparatus; and
determine, in a case where the position information of the first terminal and the position information of the own apparatus indicate that the first terminal and the own apparatus are within a predetermined distance, whether or not the user of the first terminal and the user of the own apparatus are the same.

6. The information processing apparatus according to claim 2, wherein
the at least one processor is further configured to execute the set of instructions to:
acquire position information of the first terminal and position information of the own apparatus; and
determine, in a case where the position information of the first terminal and the position information of the own apparatus indicate that the first terminal and the own apparatus are within a predetermined distance, whether or not the user of the first terminal and the user of the own apparatus are the same.

7. The information processing apparatus according to claim 1, wherein the first user information and the second user information are acceleration information.

8. The information processing apparatus according to claim 2, wherein the first user information and the second user information are acceleration information.

9. The information processing apparatus according to claim 1, wherein the first user information includes biometric information of the user of the first terminal, and
wherein the second user information includes biometric information of the user of the own apparatus.

10. The information processing apparatus according to claim 9, wherein
the at least one processor is further configured to execute the set of instructions to:
analyze a walking pattern of the user of the first terminal based on the first user information;
analyze a walking pattern of the user of the own apparatus based on the second user information; and
determine whether or not the user of the first terminal and the user of the own apparatus are the same based on similarity between the walking pattern of the user of the first terminal and the walking pattern of the user of the own apparatus.

11. A control method of an information processing apparatus, the control method comprising:
acquiring first user information detected by a first sensor mounted on a first terminal;
acquiring second user information detected by a second sensor mounted on own apparatus;
determining whether or not a user of the first terminal and a user of the own apparatus are the same based on similarity between the first user information and the second user information;
determining whether or not the user of the first terminal has received valid authentication on the first terminal;
causing, in a case where the user of the first terminal and the user of the own apparatus are the same and the user of the first terminal has received the valid authentication on the first terminal, the first terminal and the own apparatus to cooperate with each other.

12. A non-transitory computer-readable storage medium storing a program causing a computer mounted on an information processing apparatus to perform processing for:
acquiring first user information detected by a first sensor mounted on a first terminal;
acquiring second user information detected by a second sensor mounted on own apparatus;
determining whether or not a user of the first terminal and a user of the own apparatus are the same based on similarity between the first user information and the second user information;
determining whether or not the user of the first terminal has received valid authentication on the first terminal;
causing, in a case where the user of the first terminal and the user of the own apparatus are the same and the user of the first terminal has received the valid authentication on the first terminal, the first terminal and the own apparatus to cooperate with each other.
